(19) United States
(12) Patent Application Publication
(10) Pub. No.: US 2007/0071849 A1
(43) Pub. Date: Mar. 29, 2007

(54) Methods and Compositions for Increasing Feeding or Production Characteristics in Animals

(76) Inventor: Larry C. McNeff, Anoka, MN (US)

Correspondence Address: PAULY, DEVRIES SMITH & DEFFNER, L.L.C., P.O. BOX 2960, MINNEAPOLIS, MN, 55402-2960, US

(21) Appl. No.: 11/535,955

(22) Filed: Sep. 27, 2006

Related U.S. Application Data
(60) Provisional application No. 60/721,933, filed on Sep. 29, 2005.

(51) Int. Cl. A23K 1/18

(52) U.S. Cl. 426/2

(57) ABSTRACT

The invention is related to methods and compositions for increasing feeding and/or production characteristics in animals using a saponin containing composition in combination with a yeast composition. In an embodiment, the invention includes a method for improving feeding characteristics of an animal including administering a first composition including an effective amount of saponins to the animal, and administering a second composition including an effective amount of yeast to the animal. In an embodiment, the invention includes a method for improving production characteristics of an animal including administering a first composition including an effective amount of saponins to the animal, and administering a second composition including an effective amount of yeast to the animal. In an embodiment, the invention includes a composition for improving feeding characteristics of an animal including an effective amount of saponins, and an effective amount of a yeast product.

This application claims the benefit of U.S. Provisional Application Ser. No. 60/721,933, filed Sep. 29, 2005, the contents of which is herein incorporated by reference.

### FIELD OF THE INVENTION

The invention is related to methods and compositions for improving feeding and/or production characteristics in animals. More specifically, the invention is related to methods and compositions for increasing feeding and/or production characteristics in animals using a saponin composition in combination with a yeast composition.

### BACKGROUND OF THE INVENTION

Of the total costs involved with livestock production, feed costs are the most significant. Accordingly, maximizing feeding efficiency and productive output are of the utmost importance to the livestock industry. The digestive system in animals is one aspect to consider when trying to improve feeding efficiency and/or productive output.

With reference to dairy and beef cows, ingested feed first passes into the reticulorumen, where it is subject to anaerobic microbial fermentation. This microbial fermentation begins the digestive process and gives the ruminant the ability to utilize fibrous feeds that the mammalian system alone cannot break down due to the lack of necessary enzyme systems. The host animal subsequently meets its nutrient needs by utilizing the by-products of this extensive fermentation, along with any undigested feed residues and the resultant microbial mass that passes from the rumen.

Different techniques have been utilized in order to improve feeding efficiency and/or productive output in animals including the use of feed additives and ionophores. Examples of feed additive techniques can be found in U.S. Pat. No. 5,496,571 (Blagdon et al.), U.S. Pat No. 5,219,596 (Smith et al.), and U.S. Pat No. 4,388,327 (Cummins). An example of an ionophore is monensin sodium (CAS Reg. #22373-78-0) sold under the tradename RUMENSIN®. However, administration of RUMENSIN® must be tightly controlled because overdosing can be detrimental to animal health and feeding characteristics.

Accordingly, a need exists for methods and compositions that will improve feeding characteristics such as feeding efficiency and/or productive output in animals.

### SUMMARY OF THE INVENTION

The invention is related to methods and compositions for increasing feeding and/or production characteristics in animals using a saponin composition in combination with a yeast composition. In an embodiment, the invention includes a method for improving feeding characteristics of an animal including administering a first composition including an effective amount of saponins to the animal, and administering a second composition including an effective amount of yeast to the animal.

In an embodiment, the invention includes a method for improving production characteristics of an animal including administering a first composition including an effective amount of saponins to the animal, and administering a second composition including an effective amount of yeast to the animal.

In an embodiment, the invention includes a method for improving production characteristics of an animal including administering to an animal a composition comprising an effective amount of saponins and an effective amount of yeast.

In an embodiment, the invention includes a composition for improving feeding characteristics of an animal including an effective amount of saponins, and an effective amount of a yeast product.

The above summary of the present invention is not intended to describe each discussed embodiment of the present invention. This is the purpose of the detailed description that follows.

### DETAILED DESCRIPTION OF THE INVENTION

Feeding costs make up the single largest cost of the total costs involved with animal and animal product production. Accordingly, improving feeding and production characteristics are of the utmost importance to the livestock industry. Feeding and production characteristics can include feeding efficiency, total dry matter intake, productive output, weight gain, and the like. Embodiments of the invention include methods and compositions for improving feeding and/or production characteristics in animals using a saponin composition in combination with a yeast composition.

One approach to improving animal production characteristics is the use of yeast cultures. Yeast cultures have been shown to have selective stimulatory effects on certain groups of bacteria in the rumen (Dawson, 2000, Proceedings of Alltech's 16th Annual Symposium (K. A. Jacques and T. P. Lyons, eds.) Nottingham University Press, U.K. p. 473-486). It has been shown that yeast culture supplements can stimulate microbial activities and increase the concentrations of bacteria in the rumen (Girard et al., 1993, J. Anim. Sci., 71(Suppl. 1):288). Many of the bacteria that are stimulated are critical to the process of fiber digestion in the rumens of animals fed fibrous substrates or to lactic acid utilization in the rumens of animals receiving grain-based, high-energy diets (Girard et al., 1993, J. Anim. Sci., 71(Suppl. 1):288). Further, the protein produced by bacteria is highly digestible by the ruminant and therefore ruminal bacteria serve to increase ruminal efficiency.

However, protozoa can act as predators to bacteria, archaea, and yeast, reducing beneficial effects of these organisms. Protozoa are microscopic animals that occur in nature as single cells. They comprise a sub-kingdom consisting of single cellular organisms that are the simplest in the animal kingdom. They can range in size from submicroscopic to macroscopic and are divided into seven phyla: Sarcomastigophora, Labyrinthomorpha, Apicomplexa, Microspora, Ascetospora, Myxozoa, and Ciliophora. Protozoa can make up to 50% of the bio-mass of a rumen. Initially, ruminal protozoa were assumed to be important for the welfare of their host ruminants. However, protozoa have been found to be predators of beneficial rumen microbes including bacteria, archea, and yeasts. A past research study showed that a single protozoan can engulf up to 21,000 bacterial organisms per hour. Protozoa ingest and digest bacteria in the rumen decreasing the flow of the high-quality microbial protein from the rumen that can be used by the animal for growth or milk production. Therefore protozoa effectively insert an energy-wasting step in the synthesis of bacterial protein in the rumen. When yeasts are introduced to the rumen, they too can suffer from predation by protozoa. Therefore, reducing the number of ruminal protozoa when feeding cattle beneficial microbial products such as yeast can enhance beneficial effects.

Reduction of ruminal protozoa can also increase rumen efficiency through other mechanisms. Specifically, ruminal protozoa have been shown to produce hydrogen in the rumen, which is then utilized by the methanogens to produce methane, which is then belched out of the cow during eructation. Methane production is carried on at the nutrient-expense of the host cow. Therefore, reduction of ruminal protozoa can also increase rumen efficiency by reducing methane production.

Beyond rumen efficiency, there are also other reasons to reduce populations of ruminal protozoa. Specifically, ruminal protozoa have come to be viewed as a serious disease-carrying threat. Recent published accounts suggest that some types of protozoa and amoebae can harbor pathogenic bacteria. Quaife, 2005 (September), Dairy Herd Management, 71-72.

Saponins can play a role in reducing or eliminating rumen protozoa. Saponins (triterpenoid, steroidal, or alkaloid) have a hemolytic action that is believed to be related to their affinity for cell membrane sterols that are embedded in the lipid bi-layer, particularly cholesterol. Saponins have been shown to form insoluble complexes with cholesterol and thereby open holes in cell membranes. The ability of saponins to rupture cell membranes, but yet be non-toxic to mammals when ingested orally makes them a suitable protozoan eliminator and methane production reducer for use in ruminants.

It is believed that the administration of yeast and saponins in combination can synergistically improve feeding and/or production characteristics. Specifically, it is believed that yeast can stimulate the production of nutritionally beneficial bacteria while saponins can reduce the predatory effects of protozoa on the yeast. Further, while not intending to be bound by theory, it is believed that saponins have little inhibitory effect on many of the beneficial bacteria stimulated by yeast.

It is also believed that both yeast and saponins have the potential to affect bacteria involved in the accumulation and/or elimination of lactic acid in the rumen in a manner that enhances productivity. Lactic acid accumulation can lead to ruminal acidosis, which is characterized by a sharp decrease in rumen pH and reduced rumen efficiency. Yeast culture tends to stimulate bacteria that actively convert lactic acid to propionate (Girard et al., 1993, J. Anim. Sci., 71(Suppl. 1):288), and it is believed that saponins inhibit bacteria that produce lactic acid or bacteria that rapidly degrade readily degradable carbohydrates and favor lactic acid production.

Therefore, in an embodiment, the invention includes a method for improving feeding characteristics of an animal including administering a first composition including an effective amount of saponins to the animal, and administering a second composition including an effective amount of a yeast or yeast product to the animal. The first and second composition can be combined as one composition or administered separately. In an embodiment, the invention includes a method for improving production characteristics of an animal including administering a first composition including an effective amount of saponins to the animal, and administering a second composition including an effective amount of a yeast or yeast product to the animal.

Yeast Compositions

Yeast compositions used in embodiments of the invention may include active dry yeast and/or yeast culture products. Yeast culture products can include live or dead yeast cells, the media the yeast was grown on, and metabolites made by the yeast cell. Yeast compositions can also include other components such as carriers, fillers, flavorings, binders, and the like.

The yeast organism used in yeast compositions of the present invention may include any of a number of edible yeasts including, but not limited to, Saccharomyces, Candida, Kluyveromyces, or Torulaspora species. In an embodiment, the yeast used can include Saccharomyces cerevisiae strain 1026. The yeast organism can be grown following common techniques used in food-related fermentations and the beverage industries. Any of a number of common sugar-containing media, such as diluted molasses, may be used to provide a source of sugars for growth of the yeasts. Other media which may be employed include wood sugars, sulfite waste liquor, and whey. The yeast biomass may then be separated and washed by centrifugation to yield a yeast cream. Yeast products are also available commercially such as YEA-SACC® 1026 from Alltech, Inc., Nicholasville, Ky.; Levucell SC I-1077 from Lallemand Animal Nutrition, France; and Diamond V XP Yeast Culture from Diamond V Mills, Inc., Cedar Rapids, Iowa.

In some embodiments, yeast compositions include 1.0×10¹⁰ CFU (colony forming units) per gram. In some embodiments, yeast compositions include 1.5×10¹⁰ CFU (colony forming units) per gram. In some embodiments, yeast compositions include 2.0×10¹⁰ CFU (colony forming units) per gram.

Yeast compositions may be formulated for administration as a liquid or as dry matter. Yeast compositions of the invention may be administered to an animal as a single dose or as a plurality of daily doses. In an embodiment, the doses are continued for at least 30 days. In an embodiment, the doses are continued for at least 60 days.

The total amount of yeast composition administered may vary based on factors such as concentration of the yeast composition, the size of the animal, season, ration components, and the like. In some embodiments, about 0.1 grams to about 100 grams of a yeast composition are administered per animal per day (head/day). In some embodiments, about 0.1 grams to about 10 grams of a yeast composition having at least about 1.5×10¹⁰ CFU per gram are administered per animal per day (head/day).

Yeast compositions can also be administered by mixing them in with the daily feed ration. A sufficient amount of a yeast composition can be mixed into the daily feed ration in order to produce desired results. In some embodiments, from about 10 to about 500 grams of a yeast composition are mixed into a metric ton of dry feed.

Saponin Compositions:

Saponins are natural plant surfactants that occur in over 500 different plant species belonging to some 80 different families. Saponins are generally recognized by their strong foaming action when placed in water, which has made them especially useful in the manufacture of foods, beverages, shampoos, wetting agents and pharmaceuticals.

Saponins are classified as surfactants because they have both lipophilic and hydrophilic “regions”. Thus, the surfactant activity of saponins is a result of both fat-soluble and water-soluble moieties in the same molecule. The lipophilic region may be a steroid, triterpene or alkaloid, and is termed a sapogenin. The hydrophilic “region” contains one or more water-soluble carbohydrate side chains. Yucca derived saponins generally have steroidal sapogenins. Sarsasapogenin is the major sapogenin found in the Yucca schidigera plant. Saponins have an antiprotozoal activity attributed to the saponin's ability to interact with cholesterol in protozoal cell membranes and cause cell lysis. The structural complexity of saponins is derived largely from the carbohydrate portion of the molecule due to the many different types of possible side chain carbohydrates, such as glucose, xylose, galactose, pentose or methylpentose, which may have different connectivity and/or anomeric configuration.

Saponins useful in the present invention can be extracted from plants of the family: Amaryllidaccae, genus: Agave, which grows extensively in the southwestern United States and in Mexico. Saponins useful in the present invention may also be extracted from plants of the family: Lillaecae, genus: Yucca, such as Yucca schidigera. Saponins may also be obtained from extracts of soybeans, fenugreek, peas, tea, yams, sugar beets, alfalfa, asparagus, aloe, vanilla, zhimu (or zhi-mu, or Anemarrhena root), Sapindus saponaria, as well as from Quillaja saponaria bark. Saponins may be extracted from plant materials in accordance with techniques well-known by those of skill in the art.

The typical saponin content that naturally occurs in yucca plants is from 0.1-2% saponins by weight. Yucca extracts can be derived by extracting yucca powder with an aqueous solution that may or may not contain some fraction of organic solvent such as methanol, ethanol, propanol, butanol, or the like. Commercially available Yucca extracts can have a total solids content usually in the range from 5-50%. The saponin content of a typical 50 brix (50% solids by weight) yucca extract is usually in the range of about 1-2% saponins by weight as measured by HPLC analysis. Another method of measuring total saponin content is the extraction of all soluble components into a butanol extract followed by gravimetric analysis of the compounds dissolved in the butanol fraction. Measuring saponin content by the butanol extract method typically results in higher numbers than the more advanced HPLC method. Accordingly, the typical 50 brix (50% solids by weight) yucca extract is usually in the range of about 5-20.0% saponins content by weight as measured by the butanol extract method.

Saponin compositions in accordance with the invention may be in liquid or dry forms. By way of example, a saponin containing plant extract may be dried into a powder form. In this form, the saponin composition may be administered to an animal as a pill or bolus, or mixed in with other components such as a feed ration. Saponin containing plant extract may also be in a solution with an amount of a carrier liquid such as water. In this form, the composition may be administered to an animal as a liquid drench.

Saponin compositions of the invention may be administered to an animal as a single dose or as a plurality of daily doses. In an embodiment, the doses are continued for at least 30 days. In an embodiment, the doses are continued for at least 60 days.

The effectiveness of saponin compositions in accordance with the invention can be related to the concentration of saponins contained therein. In an embodiment, the saponin composition used in accordance with the invention comprises at least 0.1% by weight (w/w) saponins as measured by HPLC. In an embodiment, the saponin composition used in accordance with the invention comprises at least 0.5% by weight (w/w) saponins as measured by HPLC. In a particular embodiment, the saponin composition used in accordance with the invention comprises at least 1.0% by weight (w/w) saponins as measured by HPLC. It is believed that the effects of the composition are related to the total amount of saponins present. Thus, one of skill in the art will appreciate that if a certain amount of saponins is desired it can be achieved either through varying the volume of a certain concentration composition administered, varying the concentration of a certain volume of a composition, or both.

In some embodiments, the saponin composition administered comprises at least about 50 ml of a composition containing at least about 0.1 wt. % saponins as measured by HPLC analysis. In some embodiments, the saponin-containing composition administered comprises at least about 100 ml of a composition containing at least about 0.1 wt. % saponins as measured by HPLC analysis. In some embodiments, the saponin-containing composition administered comprises at least about 150 ml of a composition containing at least about 0.1 wt. % saponins as measured by HPLC analysis. In some embodiments, the saponin composition administered comprises at least about 200 ml of a composition containing at least about 0.1 wt. % saponins as measured by HPLC analysis. In some embodiments, the saponin composition administered comprises at least about 250 ml of a composition containing at least about 0.1 wt. % saponins as measured by HPLC analysis.

Exemplary liquid solutions containing saponins are available commercially and sold under the trademarks SARTEMP®, SARSTART®, SARSTART® PRO, and SARSTART® PLUS by SarTec Corporation of Anoka, Minn. These solutions are prepared by blending an aqueous extract of the plants of the family: Lillaecae, genus: Yucca, or other appropriate Yucca plants with antifreeze agents such as calcium chloride, propylene glycol, and the like, to depress the freezing point to approximately −30° F. These liquid solutions may also comprise a variety of other components. By way of example, SARSTART® PLUS can contain the following ingredients: Water, Propylene Glycol, Yucca Schidigera Extract, Vitamin E (as di-alpha-tocopheryl acetate), Vitamin A Propionate, Vitamin A Palmitate, Vitamin B1, Vitamin B2, Vitamin B6, Vitamin B12, D-Activated Animal Sterol (source of Vitamin D3), Naturally Occurring Organisms, Dried Egg Solids, Dried Casein, and Dried Whey. The physical and chemical characteristics of SARSTART® PLUS are as follows: Boiling Point: 240 F; Specific Gravity: 1; Melting Point: −20 F; Solubility in Water: Miscible; Appearance and Odor: Dark brown liquid with a mild odor and a slightly acid taste. Saponin compositions can also be formulated as dry powder. Such dry formulations are available commercially (SARSTART® D, SARSTART® DSC, SarTec Corporation, Anoka, Minn.). Dry powder formulations of saponin compositions may be added to the feed ration via a micro-ingredient machine or added to a feed mix truck and mixed thoroughly to assure even distribution in the feed.

The saponin composition can be administered together with, or separately from, the yeast composition. The saponin composition and the yeast composition can be formulated together as one composition for administration.

The present invention may be better understood with reference to the following examples. These examples are intended to be representative of specific embodiments of the invention, and are not intended as limiting the scope of the invention.

### EXAMPLES

### Example 1

### Combined Effect of Saponins and Yeast Culture Products

Dairy cattle are randomly divided into four groups: Group 1 (control), Group 2 (Saponins), Group 3 (Yeast Cultures), and Group 4 (Saponins and Yeast Cultures). The groups are housed in separate pens and given ad libitum access to feed and water. Daily milk production is monitored for all four groups. Group 1 (control) is not given a saponin containing composition or yeast cultures. Group 2 is given a 4 ml daily dose of a composition (SARSTART® LSC, SarTec, Anoka, Minn.) containing about 0.1 wt. % (as measured by HPLC) saponins. Group 3 is given a daily dose of yeast cultures (YEA-SACC 1026, Alltech, Inc., Nicholasville, Ky.). Group 4 is given both a 4 ml daily dose of a composition (SARSTART® LSC, SarTec, Anoka, Minn.) containing about 0.1 wt. % saponins and a daily dose of yeast cultures (YEA-SACC 1026, Alltech, Inc., Nicholasville, Ky.). The trial is conducted for 90 days. The data show that those dairy cows receiving both a saponin containing composition and yeast cultures produce a greater amount of milk on average than any other group tested.

All references contained herein to amounts of saponins are as measured by HPLC analysis unless specifically indicated otherwise. All publications and patent applications in this specification are indicative of the level of ordinary skill in the art to which this invention pertains. All publications and patent applications are herein incorporated by reference to the same extent as if each individual publication or patent application was specifically and individually indicated by reference.

The invention has been described with reference to various specific and preferred embodiments and techniques. However, it should be understood that many variations and modifications may be made while remaining within the spirit and scope of the invention.

We claim:

1. A method for improving feeding characteristics of an animal comprising:
administering a first composition comprising an effective amount of saponins to the animal, and
administering a second composition comprising an effective amount of yeast to the animal.

2. The method of claim 1, wherein improving feeding characteristics comprises increasing dry matter intake.

3. The method of claim 1, wherein improving feeding characteristics comprises increasing feeding efficiency.

4. The method of claim 1, wherein the first composition and the second composition are administered simultaneously.

5. The method of claim 1, the animal selected from the group consisting of beef cattle, dairy cows, sheep, and goats.

6. The method of claim 1, the animal comprising a ruminant.

7. The method of claim 1, the animal comprising Bos taurus.

8. The method of claim 1, the first composition comprising an extract of one or more of agave, yucca, soybeans, fenugreek, peas, tea, yams, sugar beets, alfalfa, asparagus, aloe, vanilla, zhimu, Sapindus saponaria, or Quillaja saponaria.

9. The method of claim 1, the first composition comprising a yucca extract.

10. The method of claim 1, the first composition comprising at least 0.1 % by weight of saponins.

11. The method of claim 1, the first composition comprising sarsaponins.

12. The method of claim 1, the yeast comprising one or more of Saccharomyces, Candida, Kluyveromyces, or Torulaspora species.

13. The method of claim 1, the yeast comprising Saccharomyces cerevisiae.

14. A method for improving production characteristics of an animal comprising:
administering a first composition comprising an effective amount of saponins to the animal, and
administering a second composition comprising an effective amount of yeast to the animal.

15. The method of claim 14, wherein the first composition and the second composition are administered simultaneously.

16. The method of claim 14, the animal selected from the group consisting of dairy cows, sheep, and goats.

17. The method of claim 14, the first composition comprising one or more of yucca, agave, or quillaja extract.

18. The method of claim 14, the first composition comprising at least 0.1 % by weight of saponins.

19. The method of claim 14, the yeast comprising Saccharomyces cerevisiae.

20. A composition for improving feeding characteristics of an animal comprising:
an effective amount of saponins, and
an effective amount of a yeast product.
